(19) United States
(12) Patent Application Publication
(10) Pub. No.: US 2018/0073272 A1
(43) Pub. Date: Mar. 15, 2018

(54) FLEXIBLE DOOR LATCH STRIKE

(71) Applicant: Roy Fenwick, Toronto (CA)

(72) Inventor: Roy Fenwick, Toronto (CA)

(21) Appl. No.: 15/816,309

(22) Filed: Nov. 17, 2017

Related U.S. Application Data
(62) Division of application No. 15/206,386, filed on Jul. 11, 2016, now Pat. No. 9,822,550.
(60) Provisional application No. 62/190,330, filed on Jul. 9, 2015.

(51) Int. Cl. E05B 15/02; E05B 17/00; E05B 15/16

(52) U.S. Cl. CPC E05B 15/022; E05B 2015/1671; Y10S 292/38; E05B 17/007

(57) ABSTRACT

The present disclosure relates to a door strike. In particular, the present disclosure relates to a door strike comprising a base plate, and a strike tongue, wherein the strike tongue comprises a flexible material.

### RELATED APPLICATIONS

This application is a divisional of U.S. patent application Ser. No. Divisional of U.S. Ser. No. 15/206,386 filed Jul. 22, 2016 (pending), which claims the benefit of U.S. provisional application Ser. No. 62/190,330 filed Jul. 9, 2015 (now abandoned). All of the prior applications are incorporated herein by reference in their entirety.

### FIELD

The present disclosure relates to a door strike. In particular, the disclosure relates to a flexible door latch strike comprising a base plate and a strike tongue, wherein the strike tongue comprises a flexible material.

### INTRODUCTION

A conventional door lock latch is mounted on a door and is cooperatively received within a door latch strike mounted on the door jamb. A typical door latch strike is a stamped metal member having a suitable aperture for receiving the latch, which stamped metal member is secured to the door jamb by passing a pair of screws through a pair of openings—one above the latch opening and one below the latch opening—and passing the screws into the door jamb. The latch aperture on the stamped metal member overlies a similar aperture located on the door jamb. When the door is being closed, the latch is received within the aperture on the stamped metal member and the opening on the door jamb there behind, guided there by a tongue which faces toward the door when opened.

### SUMMARY

The present disclosure relates to a door latch strike, also known as a strike plate, specifically a flexible door latch strike. In one embodiment, the flexible door latch strike is for attachment to a door jamb. In one embodiment, the flexible door latch strike comprises a base plate and a strike tongue, wherein the strike tongue comprises a flexible material. The present disclosure therefore relates to a door strike, comprising:
a) a base plate having an aperture for receiving a door latch, the base plate adapted to be attached to a door jamb; and
b) a strike tongue extending outwardly from the base plate and adapted to guide the door latch to the aperture, wherein the strike tongue comprises a flexible material.

Other features and advantages of the present application will become apparent from the following detailed description. It should be understood, however, that the detailed description and the specific examples while indicating preferred embodiments of the application are given by way of illustration only, since various changes and modifications within the spirit and scope of the application will become apparent to those skilled in the art from this detailed description.

### DRAWINGS

The disclosure will now be described in greater detail with reference to the following drawings in which:

FIG. 1 is a front elevation view of a door strike in one embodiment of the disclosure;

FIG. 2 is a top plan view of a door strike in one embodiment of the disclosure; and

FIG. 3 is a rear elevation view of a door strike in one embodiment of the disclosure; and

FIG. 4 is a front elevation view of a base plate in one embodiment of the disclosure.

### DESCRIPTION OF VARIOUS EMBODIMENTS

### (I) Definitions

The term “strike tongue” as used herein refers to the portion of a door latch strike which, upon closure of a door, is first contacted by a door latch and guides the latch to the aperture of the door latch strike.

The term “flexible material” as used herein refers to any material which can form the strike tongue and guide a door latch to an aperture in a base plate, but is also deformable and resilient such that upon contact by a person or an object being transported through the doorway, the strike tongue does not snag or interfere with either, thereby avoiding injury or damage and the strike tongue returns to its original shape.

The term “Young's modulus” as used herein, is defined in accordance with the pertinent art and relates to the stiffness of a material. The Young's modulus, also known as the tensile modulus, is a measure of the stiffness of a material and is a quantity used to characterize materials.

### (II) Door Latch Strike

Typical door latch strikes comprising a base plate and a strike tongue are generally comprised solely of stamped metal materials coated with copper, nickel or another attractive finish. The strike tongue, which generally extends outwardly from the door jamb, can cause serious injury both to adults and children, including scrapes, bruises and cuts, as they pass by and make contact with the metal strike tongue. In addition, the metal strike tongue can also result in a tear to clothing and unwanted scratches or gouges in furniture as the metal tongue snags objects as they pass through a doorway.

The present disclosure relates to a flexible door latch strike. In one embodiment, the flexible door latch strike comprises a base plate and a strike tongue, wherein the strike tongue comprises a flexible material. In one embodiment, the flexible material comprising the strike tongue is able to guide a door latch to an aperture on the base plate, but is also deformable such that it reduces the likelihood of injury, and also reduces the likelihood of objects, such as clothing, furniture, being snagged on the strike tongue. In one embodiment, the door latch strike is a safety door strike which reduces or prevents injury as a result of the flexible strike tongue.

In one embodiment of the disclosure, there is included a door latch strike, comprising:
i) a base plate having an aperture for receiving a door latch, the base plate adapted to be attached to a doorjamb; and
ii) a strike tongue extending outwardly from the base plate and adapted to guide the door latch to the aperture, wherein the strike tongue comprises a flexible material.

In one embodiment, the base plate comprises at least one opening for receiving a fastener to secure the base plate to the door jamb. In another embodiment, the base plate comprises a first and second opening. In a further embodiment, the first opening is located above the aperture and the second opening is located below the aperture. In one embodiment, a fastener, such as a screw or nail, passes through the first and/or second openings to fasten the door strike to a door jamb.

In other embodiments, the door latch strike is fastened to the door jamb by any means which secures the door latch strike to the door jamb, such as gluing the door latch strike to the door jamb, or welding the door latch strike to the door jamb.

In another embodiment, the base plate is a metal plate, which may be optionally coated with copper, nickel or other attractive finishes.

In another embodiment of the disclosure, the strike tongue is curved away from the latch. In another embodiment, the strike tongue is curved away from the door latch so that the tip of the strike tongue does not interfere with the door latch when it first contacts the door latch strike.

In another embodiment of the disclosure, the thickness of the strike tongue becomes gradually thicker from the base plate to the edge or front of the strike tongue to buffer the force by the latch upon contact. Existing metal strike plates are generally approximately 1/16^{th} of an inch thick. In one embodiment, the strike plate of the present disclosure is of a similar thickness resulting in facile replacement of existing plates.

In another embodiment of the disclosure, the flexible material is any material which guides a door latch to the aperture on the base plate, and is deformable such that it reduces or prevents injury if a person or object contacts the outwardly extending strike tongue, and returns to its original shape after contact by the door latch, person or object. In another embodiment, the flexible material has a Young's Modulus of less than about 1.0 GPa (Gigapascals), or less than about 0.5 GPa, or less than about 0.1 GPa. In one embodiment, the flexible material is an elastomer. In one embodiment, the flexible material is an elastomer and has a Young's Modulus of less than about 1.0 GPa (Gigapascals), or less than about 0.5 GPa, or less than about 0.1 GPa.

Examples of elastomers include, but are not limited to, polyurethanes, copolyetheresters, rubbers (including butyl rubbers, and natural rubbers), polybutadienes, nitrile rubbers, styrene/butadiene copolymers, styrene/ethylene/butadiene/styrene copolymers (SEBS), polyisoprene, ethylene/propylene copolymers (EPR), ethylene/propylene/diene monomer copolymers (EPDM), polysiloxanes, and polyethers (such as poly(ethylene oxide), poly(propylene oxide), and their copolymers).

Additional examples of elastomers epichlorohydrin rubber, polyacrylic rubber, silicone rubber, fluorosilicone rubber, fluoroelastomers, perfluoroelastomers, polyether block amides, ethyl vinyl acetate, thermoplastic elastomers, such as thermoplastic olefins, thermoplastic polyurethanes, thermoplastic copolyesters, and thermoplastic polyamides. In one embodiment, the flexible material is a polyurethane elastomer, such as F170.

In one embodiment, the flexible material is a rubber or plastic, for example vulcanized rubber. In one embodiment, the plastic is a deformable plastic, which includes any polymer, for example, a thermoplastic polymer, which can be deformed, without fracturing, exhibiting cracks or thermally decomposing, and is sufficiently elastic to return to its original shape after deformation. In another embodiment, the flexible material is a thermoplastic polyurethane.

In another embodiment, the strike tongue comprises a rubber portion. In another embodiment, the strike tongue comprises a plastic portion. In another embodiment of the disclosure, strike tongue comprises a flexible material which has a low coefficient of friction, such that the door latch easily glides across the strike tongue to the aperture of the base plate. In another embodiment, the flexible material is coated with a material having a low coefficient of friction, such as a polymer.

In another embodiment of the disclosure, the base plate and the strike tongue both comprise a flexible material, which may be the same or different.

In another embodiment, the flexible strike tongue is attached to the base plate by any mechanical or chemical means, for example, by gluing (or using any other adhesive substance, such as epoxy, polyurethane, etc.) the strike tongue to the base plate. In another embodiment, the strike tongue is fastened by nails and/or screw.

In one embodiment, the attachment means of the base plate and strike tongue may or may not be permanent but may allow for the removal and replacement of either the base plate or strike tongue areas without changing the other.

Referring to the drawings, it is seen that the door latch strike of the present disclosure, generally denoted by reference numeral 10, is comprised of a base plate 12, which has an aperture 14, and a strike tongue 16.

In one embodiment, as shown in FIGS. 1-3, the door strike is comprised of two separate sections, the base plate 12 and the strike tongue 14, which are attached together by appropriate means. In other embodiments, the base plate and strike tongue are comprised of the same material resulting in a single contiguous strike plate with flexible tongue.

In one embodiment, the latch strike as seen in FIG. 1 is secured to a door jamb by passing a screw through each of the upper 18 and lower 20 channels, located above and below the aperture 14 in the base plate 12. In this embodiment, the screw or nail openings are not single holes but rather elongated openings to accommodate the possible shifting of the flexible door latch strike, as may be required, to ensure a proper fit into the footprint in the door jamb. Alternatively, the flexible door latch strike may not have upper and lower channels 18 and 20, as the door latch strike may be attached to the door jamb with glue or other adhesive means. In another embodiment, the upper and lower channels 18 and 20 may be circular openings to allow passage of a screw or nail. The depending lip 22 extends inward from the aperture 14 of the flexible door strike latch 10, to help secure the strike in the aperture in the door jamb and also assist in securing the door latch within the strike aperture itself.

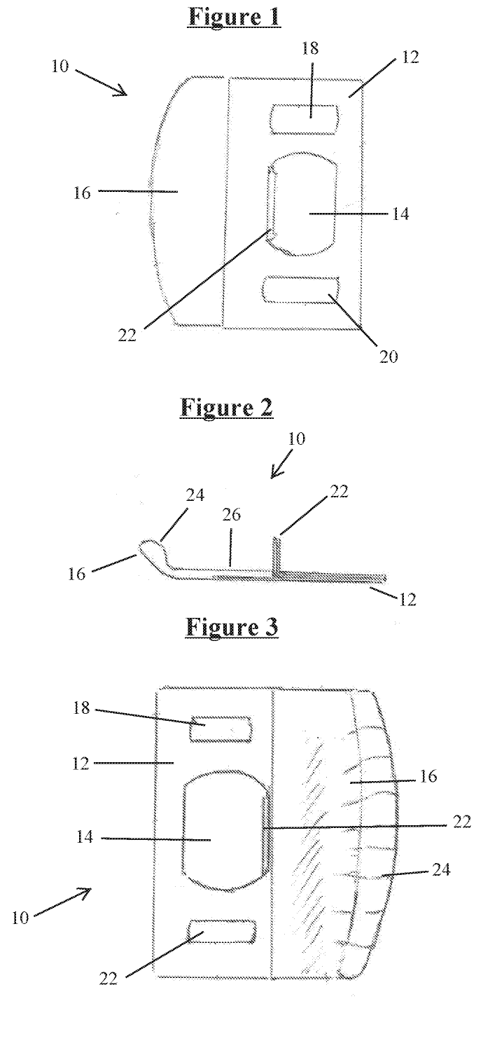

FIG. 2 is a top plan view of a flexible door latch strike 10, having a base plate 12, a flexible strike tongue 16, a depending lip 22, and a tongue buffer 24, the tongue buffer 24 providing additional support to the strike tongue 16 upon contact with the door latch. Overlap area 26 shows the overlap and attachment of the base plate to the flexible strike tongue.

FIG. 3 shows the rear elevation view of a flexible door latch strike 10, the elongated channels 18 and 20 to attach the flexible door latch strike to the door jamb, the aperture 14, the depending lip 22. In addition, FIG. 3 shows a rear view of the tongue buffer 24, an extension of the tongue material into a roll curled behind the front of the tongue. The tongue buffer supports and cushions the tongue from the force of the door latch when it impacts the soft latch strike area thus providing a smooth transition for the door latch on its path to the aperture.

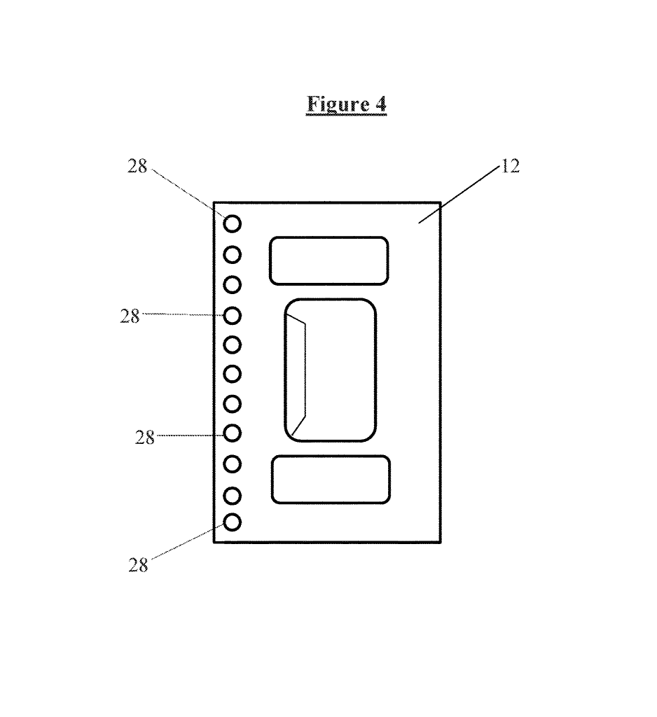

FIG. 4 shows a front elevation view of a base plate 10, for example a metal base plate optionally with a finishing coat, having a plurality of holes 28 bored through the plate. In one embodiment, holes 28 are used in the manufacturing of the strike plate of the present disclosure, in which a moldable flexible material is bonded to the base plate by coating both sides of the base plate from the depending lip forward, while simultaneously flowing through the holes to bind with the base plate and forming the flexible tongue of the door strike. Depending on the nature of the flexible material, in one embodiment, the flexible material is heated during the manufacturing process such that it is able to flow and form the flexible strike tongue (for example, a rubber). In another embodiment, the flexible material during the manufacturing process is an uncured polymer, such as an uncured thermoplastic urethane, and after contacting with the base plate is cured to form the strike tongue of the flexible door strike.

The following non-limiting examples are illustrative of the present disclosure:

### EXAMPLES

### Example 1: Flexible Door Strike

A metallic base plate having dimensions of approximately 2 ¼^{″} (length) by 1 6/16″ (width) by 1/16″ (depth), with an aperture of 1″ by ⅝″ was obtained. A flexible strike tongue was securely fastened with glue to the metallic base plate. The resulting flexible door strike had similar dimensions to common metallic door strikes.

The flexible door strike was then attached to a door jamb, and a door, having a door latch was closed as per standard procedure. The flexible tongue guided the door latch to the aperture of the base plate.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

Although the disclosure has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present disclosure.

1. A door strike, comprising:
i) a base plate having an aperture for receiving a door latch and defining a mounting surface, the base plate adapted to be attached to a door jamb; and
ii) a strike tongue having first and second ends, the first end defines a length aligned with an axis of a door about which the door rotates and a width perpendicular to the length, and the second end is configured to contact and guide the door latch to the aperture;
wherein the whole length and width of the first and second ends of the strike tongue is made of a flexible material, and
wherein the entirety of the strike tongue is flexible relative to the base plate.

2. The door strike according to claim 1, wherein the base plate comprises at least one opening for receiving a fastener to secure the base plate to the door jamb.

3. The door strike according to claim 1, wherein the base plate comprises a first opening and a second opening for receiving a fastener to secure the base plate to the door jamb.

4. The door strike according to claim 3, wherein the first opening is located above the aperture and the second opening is located below the aperture.

5. The door strike according to claim 3, wherein the first opening and the second opening are channels located above and below the aperture, respectively.

6. The door strike according to claim 1, wherein the base plate comprises a metal plate.

7. The door strike according to claim 1, wherein the strike tongue is curved away from the door latch.

8. The door strike according to claim 1, wherein the strike tongue comprises a rubber portion.

9. The door strike according to claim 1, wherein the strike tongue comprises a plastic portion.

10. The door strike according to claim 1, wherein the flexible material comprises rubber or plastic.

11. The door strike according to claim 1, wherein the flexible material has a low coefficient of friction.

12. The door strike according to claim 1, wherein the flexible material is coated with a material having a low coefficient of friction.

13. The door strike according to claim 12, wherein the material having a low coefficient of friction is a polymer.

14. The door strike according to claim 1, wherein the flexible material is a thermoplastic polyurethane.

15. The door strike according to claim 1, wherein the base plate comprises a non-metal plate.

16. The door strike according to claim 1, wherein the base plate further comprises a depending lip extending inward from the aperture.

17. The door strike according to claim 1, wherein the flexible material comprises a polymer.

18. The door strike according to claim 1, wherein the first end of the strike tongue is secured to the mounting surface.
